(19) United States
(12) Patent Application Publication
(10) Pub. No.: US 2008/0268415 A1
(43) Pub. Date: Oct. 30, 2008

(54) AUDIO BOOK

(76) Inventor: Tin Lap Kwong, Hong King (CN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/021,574

(22) Filed: Jan. 29, 2008

Related U.S. Application Data
(60) Provisional application No. 60/887,650, filed on Feb. 1, 2007.

(51) Int. Cl. G09B 5/06

(52) U.S. Cl. 434/317

(57) ABSTRACT

An audio book comprising: a plurality of leaves with an inductively-powered transponder fastened to each leaf, each transponder having a unique code, one or both of the pages of each leaf bearing printed matter; a power source mounted in the book; an processor connected to the power source and having audio related to the printed matter; and a page sensing circuit including: a reader coil for magnetically inducing an electrical current for powering the transponders; and a receiver connected to the processor for receiving the unique codes from the transponders, wherein the audio related to the matter printed on any one of the pages which is opened is played by the processor according to the unique codes received by the receiver.

### BACKGROUND OF THE INVENTION

1. Field of the Invention

The present invention pertains generally to the field of audio books which contain a page sensing circuit for identifying the pages opened and signalling a circuit to play audio related to the matter printed on the pages.

2. Description of the Prior Art

The prior art devices known as audio books (or “talking books”) consist of a book with various sensors which—when activated by touching, page turning, etc.—cause a sound generating means mounted on the book to produce or replay particular sounds. Audio books thus provide an interface for allowing a user, such as a child, to access audio corresponding to the printed text of the book via familiar printed matter.

Despite a long standing interest in the provision of printed text and images together with relevant passages of sound, no technology has found wide commercial acceptance for this purpose. There is thus a need for technology which achieves the provision of passages of sound with printed images and which is inexpensive and convenient to produce and to use.

### SUMMARY OF THE INVENTION

According to one aspect of the present invention there is provided an audio book comprising:
a plurality of leaves with an inductively-powered transponder fastened to each leaf, each transponder having a unique code, one or both of the pages of each leaf bearing printed matter;
a power source mounted in the book;
a processor connected to the power source and having audio related to the printed matter; and
a page sensing circuit including:
   a reader coil for magnetically inducing an electrical current for powering the transponders; and
   a receiver connected to the processor for receiving the unique codes from the transponders,
   wherein the audio related to the matter printed on any one of the pages which is opened is played by the processor according to the unique codes received by the receiver.

Preferably each leaf comprises two layers laminated with the transponder held therebetween. The transponders are preferably positioned in the leaves so as to be substantially non-overlapping in a direction orthogonal to the plane of the leaves when the book is closed. Each of the transponders preferably lies adjacent an area of the rear cover circumscribed by the reader coil.

The audio is preferably recorded files stored on electronic memory. Alternatively the audio book may include a speech synthesizer and the audio may be in the form of file corresponding to the printed text on the pages. The processor preferably includes an audio output mounted in the book and connected to receive signals from the processor for playing the audio. The audio output preferably comprises a speaker.

The book preferably further includes at least one cover, and the power source, audio circuit and page sensing circuit being mounted to or in the cover. Optionally the power source, audio circuit and page sensing circuit may be received in an enclosure mounted to or in the cover.

In another aspect the invention provides a method of providing a printed graphic or text with associated audio using an audio book substantially as described above, comprising:
directing a current through the reader coil to inductively couple and energise only those transponders near the coil;
receiving a unique code from each energised transponder;
periodically selecting audio associated with a combination of the unique codes of the energised transponders; and
playing the selected audio.

In still another embodiment the invention provides an audio book comprising:
a plurality of leaves with one or more inductively-powered transponders fastened to each leaf, an identity code associated with the one or more transponders of each leaf, one or both of the pages of each leaf bearing printed matter;
a power source mounted in the book;
a processor connected to the power source and having audio related to the printed matter; and
a page sensing circuit including:
   a reader coil for magnetically inducing an electrical current for powering the transponders; and
   a receiver connected to the processor for receiving signals from the transponders,
      wherein the audio related to the matter printed on any one of the pages which is opened is played by the processor according to the identity codes received by the receiver. This embodiment of the audio book also relies upon the unique identification of each page and playing associated audio, however the identity code of each page may be determined either from a single transponder with a unique code, or from transponders on the page with respective non-unique codes which combine to produce an identity code associated with the page. For example, signals simultaneously transmitted from the transponders on the page may be received in combination to produce an identity code.

It will further be understood that unique identification of each page can also be achieved where the identity codes associated with some of the pages are not unique. The determination can be based on the set of codes received, using simple deduction based the codes and respective pages that have been uniquely identified. For example, if pages with non-unique codes are placed between pages with respective unique codes, they can thereby be uniquely identified.

This invention thus provides an audio book which is effective and efficient in operational use, and which may be economically constructed.

### BRIEF DESCRIPTION OF THE DRAWINGS

FIG. 1 is a pictorial view of a book according to a preferred embodiment of the invention showing the partly open pages in staggered positions;

FIG. 2a is a plan view of the book of FIG. 1 open to expose the sides of two pages;

FIG. 2b is a fragmentary cross section through a page of the book of FIG. 1, and

FIG. 3 is a block diagram illustrating the operative electronic components of the book of FIG. 1.

### DETAILED DESCRIPTION OF THE PREFERRED EMBODIMENTS

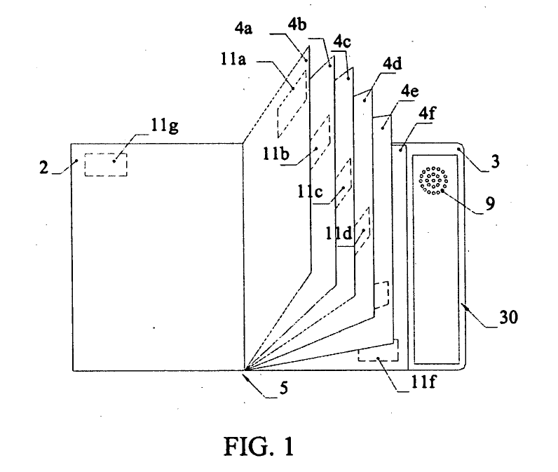

There is shown in FIG. 1 an audio book 1 including a front cover 2 and a rear cover 3. A plurality of sheets 4 (4a, 4b, 4c, etc;), each bearing printed graphics and/or text on their first and second respective sides or pages are bound to the front and rear cover 2, 3 along a spine 5 by a conventional binding. The covers 2 and 3 and sheets 4 collectively constitute the “leaves” of book 1.

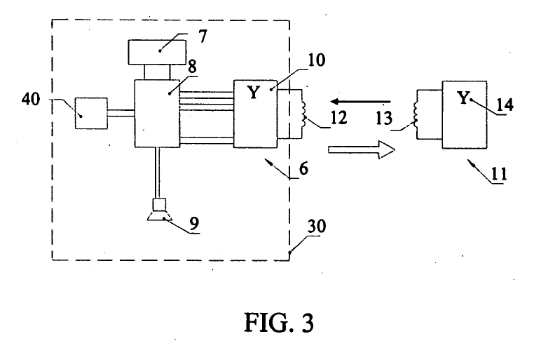

FIG. 3 depicts, in block diagram form, the operative electronic components of the audio book 1. The major components include a page sensing circuit 6, a digital memory 7, which is operatively coupled with the page sensing circuit 6, and which contains at least some speech data, and a processor 8, which operably connects the page sensing circuit 6 and memory 7. The processor 8 is configured to control the page sensing circuit 6 and a speaker 9 in the generation of sounds (including speech) from digital data selected from memory. Battery 40 powers the processor 8, speaker 9 and sensing circuit 6.

The page sensing circuit 6 includes a radio frequency receiver 10 operably coupled with and controlled by the processor 8 to receive data from transponders 11 (11a, 11b, etc). The page sensing circuit 6 further includes a reader coil 12 for magnetically inducing an electrical current for powering the transponders 11.

Each transponder 11 is a thin flat assembly and includes a magnetic transponder coil 13 and a radio frequency transmitter 14. Each transponder has a unique code.

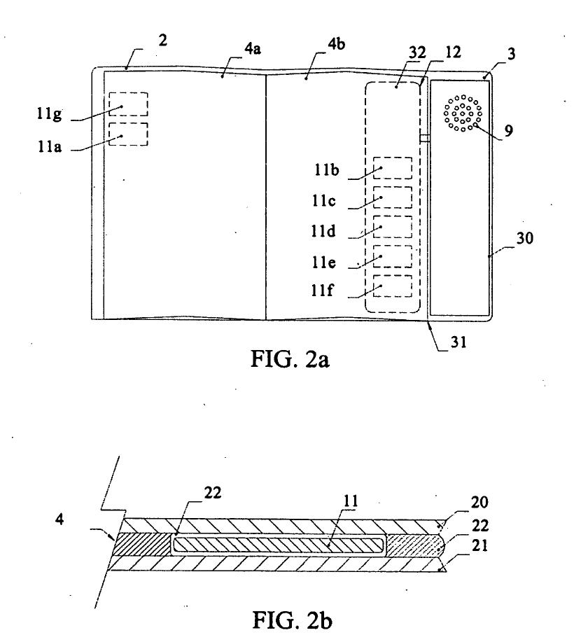

As shown in FIGS. 1 and 2b, each of the sheets 4 comprises two outer layers 20, 21 of paper laminated together on either side of a central layer 22. The central layer 22 has substantially the same thickness as the transponder 11 which is received in an aperture 23 in the central layer 22. For instance, transponder 11a is mounted between three layers comprising sheet 4a, transponder 11b between the layers comprising sheet 4b etc. In addition transponder 11g is laminated between layers comprising the front cover 2. Preferably the sides of each sheet 4 are printed following the lamination and attachment of the transponders 11.

As seen in FIG. 2a, the battery 40, processor 8, memory 7 and receiver 10 are received in a housing 30 mounted to the back cover 3. The reader coil 12 forms a flat loop embedded in the rear cover 3 adjacent the outer elongate edge 31 of the sheets 4. Formed integrally with the front cover 2, the reader coil 12 is printed onto one of the layers bonded together to form the cover 3. Each of the transponders 11 lies adjacent an area 32 of the rear cover 3 circumscribed by the reader coil 12. There is no overlap (in a direction orthogonal to the plane of the leaves) between any of the transponders 11 when the book 1 is closed.

In use, the processor periodically operates the page sensing circuit 6 to determine which of the pages are open. A current sent through the reader coil 12 generates a weak magnetic field. When the reader coil 12 and one of the transponder coils 13 are inductively coupled power is supplied to operate the transponders 11 to transmit their unique codes via transmitter 14. The magnetic field is only sufficient to energise transponders 11 close to the reader coil 12, thus the receiver 10 receives no response from some transponders 11, allowing a determination to be made as to which pages are open. Various methods are known in the art relating to the operation and control of transponders and to the avoidance of collision between the signals from the different transponders 11, so these are not described in detail.

With the pages open to expose the front of sheet 4b and the rear of sheet 4a, for example (as shown in FIGS. 2a and 3), only transponders 11b-11f are energised and transponders 11a and 11g (in the front cover and first sheet 4a) do not operate to transmit their unique codes. Associated with the combination of the unique codes of transponders 11b-11f is an audio file held in the memory 7 containing, for example, a recording of speech corresponding to the exposed text. The processor 8 then plays the file through the speaker 9. In the embodiment illustrated, no audio is played when the book is closed (the receiver 10 receives all the transponder codes) or at the end of the book when the rear cover is exposed (the receiver 10 receives no transponder codes).

Aspects of the present invention have been described by way of example only and it should be appreciated that modifications and additions may be made thereto without departing from the scope thereof.

1. An audio book comprising:
a plurality of leaves with an inductively-powered transponder fastened to each leaf, each transponder having a unique code, one or both of the pages of each leaf bearing printed matter;
a power source mounted in the book;
an processor connected to the power source and having audio related to the printed matter; and
a page sensing circuit including:
a reader coil for magnetically inducing an electrical current for powering the transponders; and
a receiver connected to the processor for receiving the unique codes from the transponders,
wherein the audio related to the matter printed on any one of the pages which is opened is played by the processor according to the unique codes received by the receiver.

2. The audio book of claim 1 wherein each leaf comprises two outer layers laminated together on either side of a central layer, with the transponder in an aperture in the central layer.

3. The audio book of claim 1 wherein the transponders are positioned in the leaves so as to be substantially non-overlapping in a direction orthogonal to the plane of the leaves when the book is closed.

4. The audio book of claim 1 wherein each of the transponders lies adjacent an area of the rear cover circumscribed by the reader coil.

5. The audio book of claim 1 wherein the audio is recorded files stored on electronic memory.

6. The audio book of claim 1 wherein the processor includes an audio output mounted in the book and connected to receive signals from the processor for playing the audio.

7. The audio book of claim 6 wherein the audio output comprises a speaker.

8. The audio book of claim 1 wherein the book further includes at least one cover, and the power source, audio circuit and page sensing circuit are mounted to or in the cover.

9. A method of providing a printed graphic or text with associated audio using an audio book substantially as claimed in claim 1, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

10. An audio book comprising:
a plurality of leaves with one or more inductively-powered transponders fastened to each leaf, an identity code associated with the one or more transponders of each leaf, one or both of the pages of each leaf bearing printed matter;
a power source mounted in the book;
an processor connected to the power source and having audio related to the printed matter; and
a page sensing circuit including:
a reader coil for magnetically inducing an electrical current for powering the transponders; and
a receiver connected to the processor for receiving signals from the transponders,
wherein the audio related to the matter printed on any one of the pages which is opened is played by the processor according to the identity codes received by the receiver. This embodiment of the audio book also relies upon the unique identification of each page and playing associated audio, however the identity code of each page may be determined either from a single transponder with a unique code, or from transponders on the page with respective non-unique codes which combine to produce an identity code associated with the page.

11. A method of providing a printed graphic or text with associated audio using an audio book substantially as claimed in claim 2, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

12. A method of providing a printed graphic or text with associated audio using an audio book substantially as claimed in claim 3, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

13. A method of providing a printed graphic or text with associated audio using an audio book substantially as claimed in claim 4, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

14. A method of providing a printed graphic or text with associated audio using an audio book substantially as claimed in claim 5, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

15. A method of providing a printed graphic or text with associated audio using an audio book substantially as claimed in claim 6, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

16. A method of providing a printed graphic or text with associated audio using an audio book substantially as claimed in claim 7, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.

17. A method of providing a printed graphic or text with associated audio using an audio book substantially as claimed in claim 8, comprising:
directing a current through the reader coil to inductively couple and energize only those transponders near the coil;
receiving a unique code from each energized transponder;
periodically selecting audio associated with a combination of the unique codes of the energized transponders; and
playing the selected audio.
